(19) United States
(12) Patent Application Publication
(10) Pub. No.: US 2010/0036032 A1
(43) Pub. Date: Feb. 11, 2010

(54) Vanish, heat-dissipation prepreg, and manufacturing method thereof

(76) Inventors: Uen-Ren Chen, Ping Chen (TW); Jeng-I Chen, Ping Chen (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/222,319

(22) Filed: Aug. 7, 2008

(51) Int. Cl. C08K 3/38; C08K 3/34; C08K 3/28; C08L 71/12; B05D 3/02; B05D 1/18

(52) U.S. Cl. 524/404; 525/396; 525/397; 524/428; 524/430; 524/442; 427/430.1; 427/397.7; 427/372.2; 524/611

(57) ABSTRACT

A vanish, a heat-dissipation prepreg, and the manufacturing method thereof are disclosed. The vanish has a curing agent with structure as indicated in formula (1). The vanish based on this curing agent will improve thermal stability and peel strength. Glass fabric cloth is dipped into the vanish having the curing agent to form a heat-dissipation prepreg with better thermal stability and peel strength. Furthermore, the curing agent has polarity so that inorganic powders are uniformly distributed in the prepreg. Therefore, the dissipation efficiency of the heat-dissipation prepreg is improved.

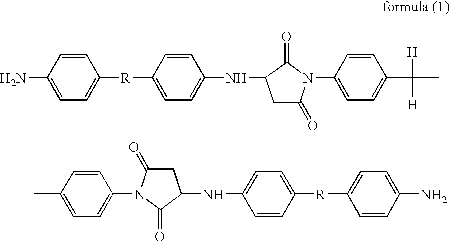

### BACKGROUND OF THE INVENTION

1. Field of the Invention

The present invention relates to a vanish, a heat-dissipation prepreg, and a manufacturing method thereof. The present invention in particular relates to a heat-dissipation prepreg with high heat-dissipation efficiency and a manufacturing method using a vanish for manufacturing the heat-dissipation prepreg.

2. Description of Prior Art

Printed circuit board (PCB) is widely used in many applications and fields, for example, electronic devices of electronic products are inserted on PCBs. Now, PCBs are increasingly applied to high power and high thermal environment. Therefore, the study and research on heat-dissipation are developed in order to improve the heat-dissipation efficiency of PCBs.

In traditional structures of PCB, the inserted electronic devices thereon have lower power and the number of inserted electronic devices is less so that the heat generated by the electronic devices can be dissipated by the Cu-foil of the PCBs and the temperature of the electronic devices is controlled by air convection. However, now-a-days electronic devices with high power are connected on the PCBs so that a lot of heat is generated and thereby increases the temperature of PCBs. Therefore, the reliability and function of the devices or products are influenced by the high temperature.

The manufacturing method for PCBs are developed for preventing the functional failure of devices resulting from overheating, for example, the heat resistance and the high heat-dissipation are highly improved as a direct result of these manufacturing methods. One technology associated with these manufacturing methods is using an adhesive layer for combining the single-layer or multi-layer PCB with a heat-dissipation metal plate (i.e. aluminum plate) and the heat generated by the devices can efficiently dissipated by the aluminum plate.

The adhesive layer is an insulation and heat-dissipation layer and it is not only provided for anchoring PCBs and the heat-dissipation metal plate but also provided for high heat-dissipation effect. The adhesive layer could be a semi-curing epoxy resin prepreg and a heat pressure method is used for attaching the PCBs and the heat-dissipation metal plate with the adhesive layer in between. The semi-curing epoxy resin prepreg is manufactured into a thin heat-dissipation prepreg by steps of dipping glass fabrics into a vanish (i.e. a resin solution), and then curing the resin.

The traditional vanish, such as the patent application of TW 200611927, has high ratio of heat-dissipation powders therein so that the prepreg can have high heat-dissipation effect after glass fabrics are dipped in the vanish. However, the ratio of the curing agent, the accelerator, and the additives must be adjusted for the high ratio of heat-dissipation powders or the heat resistance and the peel strength (i.e. adhesiveness) of the prepreg are too low to use. The curing agent is an important factor of the disadvantage. The epoxy resin of the vanish is usually bisphenol-A (BPA) resin which is co-used with curing agent of dicy (a.k.a. dicyandiamide) and curing agent of PN phenolic. Because of the high ratio of heat-dissipation powders for improving the heat-dissipation efficiency of the prepreg, the ratio of crosslink resin is so low that the characteristics of the prepreg are decreasing. For example, the prepreg manufactured by the vanish with the curing agent of dicy (dicyandiamide) has low heat resistance and the problem of de-lamination happens. On the other hands, the prepreg manufactured by the vanish with the curing agent of PN phenolic has low adhesiveness. If the ratio of the curing agent increases, the tenacity of the prepreg decreases. If the ratio of the curing agent decreases, the resin will hardly cure. Accordingly, the traditional curing agents result in some fatal problems, such as de-lamination or low adhesion, and the traditional curing agents are not suitable for manufacturing prepregs.

Therefore, in view of this, the inventor proposes the present invention to overcome the above problems based on his expert experience and deliberate research.

### SUMMARY OF THE INVENTION

The primary object of the present invention is to provide for a vanish with the curing agent. The heat-dissipation prepregs manufactured by the vanish has improved heat resistance and adhesive strength. The curing agent has a polar structure so that the powders can uniformly distributed in the vanish.

The further object of the present invention is to improve the heat-dissipation and the forming property of the heat-dissipation prepregs manufactured by the vanish.

In order to achieve the above objects, the present invention provides a vanish comprises

composition (A): epoxy resin; and composition (B): curing agent of formula (1),

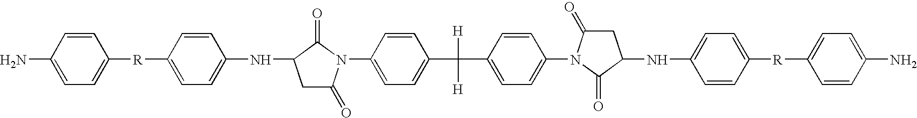

where R is selected from CH₂, O or SO₂.

In order to achieve the above objects, the present invention provides a manufacturing method of heat-dissipation prepregs comprising: (a) providing a plurality of glass fabrics; and

(b) dipping the glass fabrics into the vanish having curing agent of formula (1). The glass fabrics are manufactured into heat-dissipation prepregs by drying step and the heat-dissipation prepregs has improved heat resistance and high peel strength (i.e. adhesiveness).

The heat conducting powders are uniformly coated on heat-dissipation prepregs so that the heat-dissipation prepregs has high heat-dissipation efficiency. Moreover, the heat-dissipation prepregs can have high heat resistance and high peel strength.

In order to better understand the characteristics and technical contents of the present invention, a detailed description thereof will be made with reference to accompanying drawings. However, it should be understood that the drawings and the description are illustrative only and are not used to limit the scope of the present invention.

### DETAILED DESCRIPTION OF THE INVENTION

Please refer to formula (1), the curing agent of formula (1) is applied to the present invention.

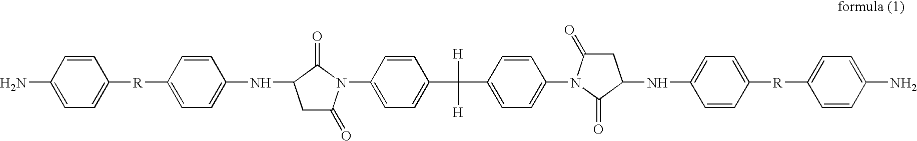

where R is selected from CH₂, O or SO₂.

The curing agent of formula (1) has two structures of imide and two structures of amine. Generally speaking, the cured resin can have property of anti-softening and heat-shock resistance (i.e. good anti-thermal characteristics) because of the structures of imide. Moreover, the cured resin has improved peel strength (adhesiveness) because of the structures of amine. Therefore, the resin cured by the curing agent of formula (1) is characterized by the properties of anti-thermal and the high peel strength. Concerning the structures of C═O and the function groups of CH₂, O or SO₂ of R, the curing agent of formula (1) has high polarity so that the powders and additives in the resin can be uniformly distributed in the vanish.

The present invention discloses that a vanish comprises composition (A): epoxy resin; and composition (B): curing agent of formula (1). The epoxy resin of composition (A) can be bisphenol-A (BPA) resin, novolac resin, novel bisphenol A-phenolic resin, brominated epoxy resin, or halogem-free epoxy resin. The composition (B) further comprises curing agent of dicy (a.k.a. dicyandiamide) and curing agent of PN phenolic. In other words, the curing agent of formula (1) can co-operate with another curing agent, such as dicy and curing agent of PN phenolic. The vanish further comprises composition (C): inorganic powders and the powders are uniformly distributed in the vanish of resin.

The present invention further discloses a manufacturing method of heat-dissipation prepregs using the resin with the curing agent of formula (1). The vanish comprising composition (A): epoxy resin and composition (B): curing agent of formula (1) are applied for the said manufacturing method. Then, glass fabrics are dipped into the vanish. The vanish has inorganic powders such as SiC (silicon carbon) powders, BN (boron nitride) powders, AlN (aluminium nitride) powders, Al₂O₃ (aluminium oxide) powders, or mixed powders of at least two powders of said SiC powder, said BN powders, said AlN powders, and said Al₂O₃ powders but the combination mentioned here is not meant to be limiting. The above-mentioned powders are inorganic heat-dissipation fillings which can be attached on the surfaces of the glass fabrics. The inorganic powders are used for dissipating heat efficiently. The curing agent of formula (1) has high polarity because of the structures of C═O and the function groups of CH₂, O or SO₂ of R so that the inorganic powders are uniformly coated on the glass fabrics. The viscosity of the vanish is below 2000 cps (centi-poise) in order to ensure better application upon the glass fabrics. After dipping the glass fabrics into the vanish, a curing step is processed for curing and desiccating the resin. Preferably, a mixing means operates for a mixing step to homogenizing the vanish in order to distribute the powders or additives in a homogenizing state when the glass fabrics are dipped into the vanish.

Accordingly, the glass fabrics are dipped into the vanish comprising composition (A): epoxy resin; and composition (B): curing agent of formula (1) to manufacture the heat-dissipation prepregs. The composition of the vanish can be adjusted in accordance with the applications. For example, the composition (B) further comprises curing agent of dicy (dicyandiamide) and curing agent of PN phenolic or the viscosity of the vanish can be changed.

The heat-dissipation prepregs manufactured by the vanish and the manufacturing method are tested to references their properties. Please refer to Table 1.

TABLE 1

| | | | The | | |
|---|---|---|---|---|---|
| | | | invention | Comparison 1 | Comparison 2 |
| Vanish | epoxy | Biphenyl-A resin | 25.9% | 47.3% | 29.4% |
| composition | | (Solid Content 90%) | | | |
| (weight ratio | Curing agent 1 | Formula 1 (Solid | 24% | — | — |
| %) | | Content 70%) | | | |
| | Curing agent 2 | Dicy (Solid Content | — | 2.6% | — |
| | | 9.09%) | | | |
| | Curing agent 3 | PN (Solid Content | — | — | 20.5% |
| | | 60%) | | | |
| | accelerator | 2-Methyl Imidazole | 0.2% | 0.2% | 0.1% |
| | | (10%) | | | |
| | powder | SiC | 50% | 50% | 50% |
| | solvent | DMF or MEK | Diluting | Diluting to | Diluting to |
| | | | to Solid | Solid | Solid |
| | | | Content | Content 70% | Content 75% |
| | | | 70% | | |
| | surfactant | BYK-W 9010 | ~0.1% | ~0.1% | ~0.1% |
| | Dispersing | time (min) | 60 | 40 | 30 |
| | state | | | | |

| | | | | |
|---|---|---|---|---|
| Property of | Solder Float Resistance | >10 | 5 | >10 |
| prepreg | (288° C., min) | | | |
| | P/S (1/1, lb/in) | 7.97 | 8.59 | 6.22 |

According to Table 1, the embodiment of the present invention employs bisphenol-A (BPA) resin (Solid Content 90%) of 25.9%, curing agent of Formula 1 of 24%, SiC powders of 50% and composition (D): at least an accelerator, at least a solvent, and at least a surfactant for dipping the glass fabrics. The characteristics of the prepregs are shown in Table 1. Bisphenol-A resin is generally produced by reacting bisphenol-A (BPA) and epichlorohydrin in NaOH. The molecule of bisphenol-A (BPA) has epoxy group with high reactivity on the end thereof. The main chain is a straight structure and has high symmetry so that bisphenol-A (BPA) has high toughness and thermal resistance. Moreover, the main chain can rotate to be flexible. The analysis is discussed below:

1. The result of solder float resistance: the test follows the instruction of IPC-TM-650 Method 2.4.13.1. The method tests heat-dissipation prepregs in 288° C. and counts the time when the prepregs has failed (De-lamination). The results present that the de-lamination time of the prepreg of the present invention is longer than that of the prepreg of comparison 1 and it means that the thermal stress and the thermal shock resistance of the prepreg of the present invention is better than that of the prepreg of comparison 1.

2. P/S result: this peel strength (P/S) follows the instructions of IPC-TM-650 Method 2.4.8. Both sides of the prepreg are attached by Cu films of 1 oz and the multi-layer structure is bonding by hot pressing. Then the step of pulling one end of the Cu film to determine the failure is proceeds. The bigger value in this test indicates that the prepreg has greater peel strength. Table 1 shows that the peel strength of the prepreg of the present invention is better than that of the prepreg of comparison 2.

3. Dispersing state test: this test is used for determining the dispersing state of each vanish. The recorded times show the powders of the vanish deposit and thus the vanish is in a clear state. Table. 1 shows that the powders is dispersed in the vanish of the present invention for a longer period than the comparisons 1 and 2. The problem of deposited powders is solved so that the powders can be uniformly coated on the glass fabrics.

Therefore, the problem that the heat-dissipation prepreg cured by curing agent of dicy (dicyandiamide) has low heat resistance and the problem that the heat-dissipation prepreg cured by curing agent of PN has low adhesive property are solved. The vanish with the curing agent of formula (1) is applied for manufacturing the heat-dissipation prepreg with high heat resistance, and high adhesive property (peel strength). Furthermore, the powders are uniformly distributed in the vanish so that the powders can be uniformly coated on the glass fabrics.

Table 2 shows the heat-dissipation efficiency of the heat-dissipation prepreg manufactured by the vanish of the present invention and two prepregs sold in the market.

TABLE 2

| | heat-dissipation prepreg | Arlon-99 | Prepreg |
|---|---|---|---|
| | of present invention | series | (non-heat-dissipation) |
| time(sec) | 42 | 43 | 80 |

The heat-dissipation efficiency is determined by a test. A thermal source with 100° C. contact one surface of each prepreg and counting the time period in which the temperature of the opposite surface of the prepreg raises form 45° C. to 65° C. The shorter time period presents the prepreg with better heat-transferring efficiency. Therein, costing the least time for the heat-dissipation prepreg of present invention to raise the surface temperature and thus the heat-dissipation prepreg of present invention has the highest heat-dissipation efficiency. Thereby it's proved that the inorganic powders are uniformly coated on the glass fabrics and the powders can efficiently dissipate heat.

To sum up, the present invention has following advantages.

1. The heat-dissipation prepreg manufactured by the vanish with the curing agent of formula (1) has improved. Furthermore, the curing agent has a polar structure so that the powders inside the vanish can be uniformly distributed in the vanish.

2. The vanish can be applied for manufacturing the heat-dissipation prepreg. The heat-dissipation efficiency and the formable property can be improved by using the vanish with the curing agent of formula (1).

Although the present invention has been described with reference to the foregoing preferred embodiment, it shall be understood that the present invention is not limited to the details thereof. Various equivalent variations and modifications may occur to those skilled in this art in view of the teachings of the present invention. Thus, all such variations and equivalent modifications are also embraced within the scope of the present invention as defined in the appended claims.

What is claimed is:

1. A vanish, comprising:
composition (A): epoxy resin; and
composition (B): curing agent of formula (1), 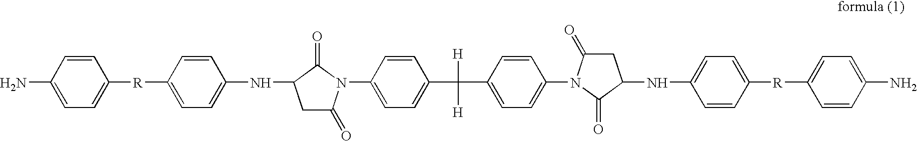
where R is selected from CH₂, O or SO₂.

2. The vanish according to claim 1, wherein the epoxy resin is bisphenol-A (BPA) resin, novolac resin, novel bisphenol A-phenolic resin, brominated epoxy resin, or halogem-free epoxy resin.

3. The vanish according to claim 2, wherein a viscosity of the vanish is below 2000 cps (centi-poise).

4. The vanish according to claim 3, wherein the composition (B) further comprises curing agent of dicy (dicyandiamide) and curing agent of PN phenolic.

5. The vanish according to claim 4, further comprising composition (C): inorganic powders.

6. The vanish according to claim 5, wherein a weight ratio of the inorganic powders of the vanish is 50%.

7. The vanish according to claim 5, wherein the inorganic powders are SiC (silicon carbon) powders, BN (boron nitride) powders, AlN (aluminium nitride) powders, Al₂O₃ (aluminium oxide) powders, or mixing powders of at least two powders of said SiC powder, said BN powders, said AlN powders, and said Al₂O₃ powders.

8. The vanish according to claim 5, further comprising composition (D): a plurality of additives.

9. The vanish according to claim 8, wherein the additives comprise at least an accelerator, at least a solvent, and at least a surfactant.

10. The vanish according to claim 9, wherein the accelerator is 2-Methyl Imidazole.

11. A manufacturing method of heat-dissipation prepregs comprising:
(a). providing a plurality of glass fabrics; and
(b) dipping the glass fabrics into the vanish of one of claims 1, 5, and 8.

12. The manufacturing method according to claim 11, further comprising a curing step after step (b).

13. The manufacturing method according to claim 12, further comprising a mixing step for homogenizing the vanish in step (b).

14. A heat-dissipation prepreg is manufactured by the manufacturing method of claim 11.
